(19) United States
(12) Patent Application Publication
(10) Pub. No.: US 2023/0239789 A1
(43) Pub. Date: Jul. 27, 2023

(54) METHOD AND APPARATUS FOR LOW-LATENCY TRAFFIC IDENTIFICATION

(71) Applicant: Samsung Electronics Co., Ltd., Suwon-si (KR)

(72) Inventors: Rubayet Shafin, Allen, TX (US); Boon Loong Ng, Plano, TX (US)

(21) Appl. No.: 18/159,565

(22) Filed: Jan. 25, 2023

Related U.S. Application Data
(60) Provisional application No. 63/303,358, filed on Jan. 26, 2022.

(51) Int. Cl. H04W 52/02; H04W 52/24

(52) U.S. Cl. CPC H04W 52/0216; H04W 52/241

(57) ABSTRACT

Methods and apparatuses for low-latency traffic identification. A method for wireless communication performed by a non-access point (AP) station comprises: receiving frames containing information pertaining to target wake time (TWT) from a corresponding AP; receiving information associated with a restricted target wake time (R-TWT) from the AP; determining whether a traffic identifier (TID) is indicated in a R-TWT Traffic Info field of an R-TWT Parameter Set field in a TWT element; and determining, based on whether the TID is indicated, whether to transmit a quality of service (QoS) Characteristics element corresponding to the TID to the AP.

### CROSS-REFERENCE TO RELATED APPLICATION(S) AND CLAIM OF PRIORITY

This application claims priority under 35 U. S. C. § 119(e) to U.S. Provisional Patent Application No. 63/303,358 filed on Jan. 26, 2022, which is hereby incorporated by reference in its entirety.

### TECHNICAL FIELD

This disclosure relates generally to efficiency in wireless communications systems. Embodiments of this disclosure relate to methods and apparatuses for low-latency traffic identification.

### BACKGROUND

Wireless local area network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Target Wake Time (TWT) is one of the important features for power management in WI-FI networks, which was developed by IEEE 802.11ah and later adopted and modified into IEEE 802.11ax. TWT enables wake time negotiation between an Access Point (AP) and an associated station (STA) for improving power efficiency. With TWT operation, it suffices for a STA to only wake up at a pre-scheduled time negotiated with another STA or AP in the network. In IEEE 802.11ax standards, two types of TWT operation are possible—individual TWT operation and broadcast TWT operation. Individual TWT agreements can be established between two STAs or between a STA and an AP. On the other hand, with broadcast TWT operation, an AP can set up a shared TWT session for a group of STAs.

Restricted TWT (R-TWT) operation is a newly introduced feature in IEEE 802.11be (WiFi 7), which provides more protection for R-TWT scheduled STAs in order to serve its latency sensitive application in a timely manner. R-TWT is based on Broadcast TWT mechanism, however, there are some key characteristics that makes R-TWT operation an important feature for supporting low-latency applications in next generation WLAN systems.

### SUMMARY

Embodiments of the present disclosure provide methods and apparatuses for low-latency traffic identification in a wireless network (e.g., a WLAN).

In one embodiment, a non-access point (AP) STA provided, comprising: a transceiver configured to: receive frames containing information pertaining to TWT from a corresponding AP; and receive information associated with a restricted R-TWT from the AP. The non-AP station includes a processor coupled to the transceiver, the processor configured to: determine whether a traffic identifier (TID) is indicated in a R-TWT Traffic Info field of an R-TWT Parameter Set field in a TWT element; and determine, based on whether the TID is indicated, whether to instruct the transceiver to transmit a quality of service (QoS) Characteristics element corresponding to the TID to the AP.

In another embodiment, a method for operating a non-AP STA is provided, the method comprising: receiving frames containing information pertaining to TWT from a corresponding AP; receiving information associated with a R-TWT from the AP; determining whether a TID is indicated in a R-TWT Traffic Info field of an R-TWT Parameter Set field in a TWT element; and determining, based on whether the TID is indicated, whether to transmit a QoS Characteristics element corresponding to the TID to the AP.

In another embodiment, a non-transitory computer readable medium is provided, the computer readable medium comprising instructions that, when executed by a processor of a non-AP station, cause the non-AP station to: receive frames containing information pertaining to TWT from a corresponding AP; receive information associated with a R-TWT from the AP; determine whether a TID is indicated in a R-TWT Traffic Info field of an R-TWT Parameter Set field in a TWT element; and determine, based on whether the TID is indicated, whether to transmit a QoS Characteristics element corresponding to the TID to the AP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure; and

FIG. 3 illustrates a flow chart of a method for operating a non-AP station according to embodiments of the present disclosure.

### DETAILED DESCRIPTION

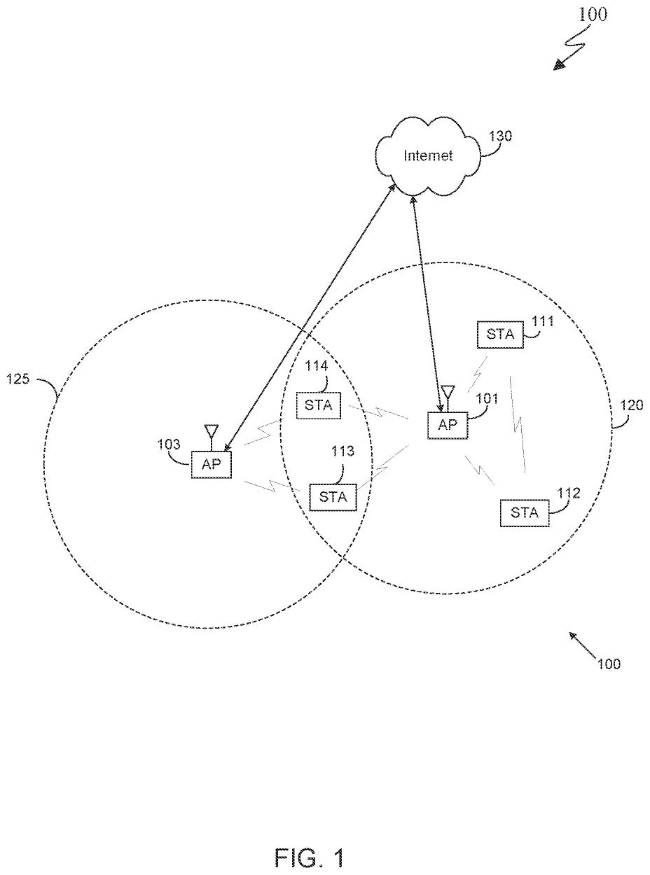

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure provide mechanisms and frameworks for identifying a latency-sensitive traffic stream for efficient operation for low-latency applications.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for low-latency traffic identification. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

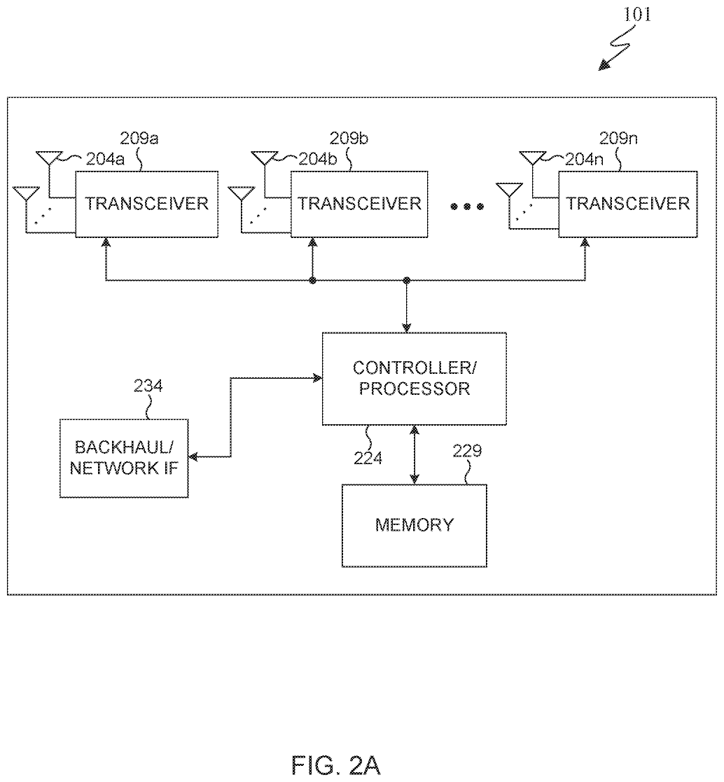

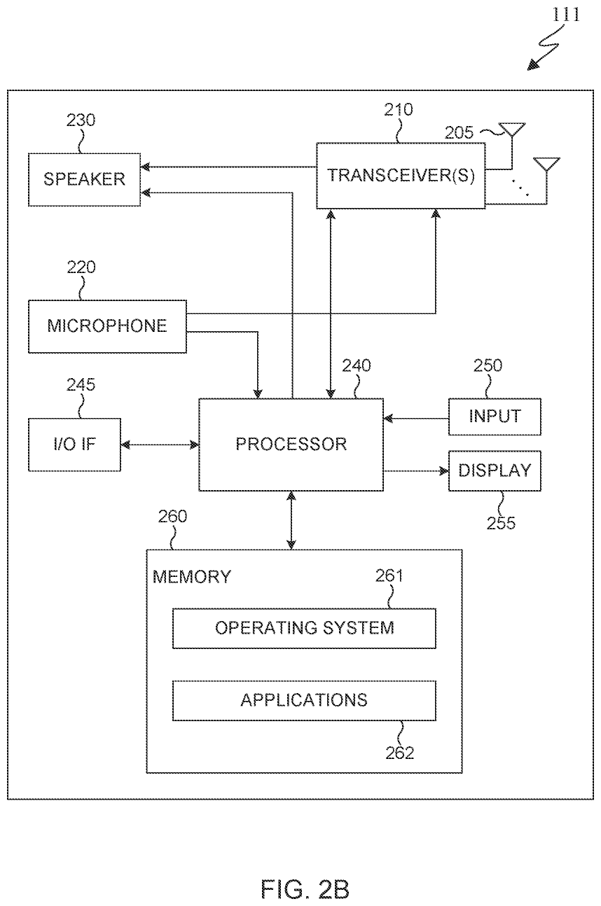

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including low-latency traffic identification. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for low-latency traffic identification. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives, from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to facilitate low-latency traffic identification. In some embodiments, the processor 240 includes at least one microprocessor or microcontroller.

The processor 240 is also capable of executing other processes and programs resident in the memory 260, such as operations for low-latency traffic identification. The processor 240 can move data into or out of the memory 260 as required by an executing process. In some embodiments, the processor 240 is configured to execute a plurality of applications 262, such as applications for low-latency traffic identification. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

The Quality of service (QoS) Characteristics element defined in 802.11be standards contains information related to the QoS requirement targeted for a latency-sensitive application. In order to identify latency-sensitive traffic identifiers (TIDs) indicated by the R-TWT scheduled STA during a R-TWT schedule setup process, the QoS Characteristics element may be integrated with the R-TWT schedule setup process. According to one embodiment, during the R-TWT schedule setup process, if an R-TWT scheduled STA indicates a TID in the R-TWT Traffic Info field of the R-TWT Parameter Set field in the TWT element, the STA also sends the QoS Characteristics element corresponding to that TID to its associated R-TWT scheduling AP.

According to one embodiment, during the R-TWT schedule setup process, if an R-TWT scheduled STA indicates a TID in the R-TWT Traffic Info field of the R-TWT Parameter Set field in the TWT element, but the R-TWT scheduled STA does not send the QoS Characteristics element corresponding to that TID to its associated R-TWT scheduling AP, the R-TWT scheduling AP responds to this TWT request by sending another TWT element with the TWT Setup Command field set to Reject TWT.

According to one embodiment, during the R-TWT schedule setup process, if an R-TWT scheduled STA indicates a TID in the R-TWT Traffic Info field of the R-TWT Parameter Set field in the TWT element, but the R-TWT scheduled STA does not send the QoS Characteristics element corresponding to that TID to its associated R-TWT scheduling AP, the R-TWT scheduling AP may respond with Alternate TWT or Dictate TWT in the TWT Setup Command field and excludes the corresponding TID from the R-TWT Traffic Info field of the R-TWT Parameter Set field in the response frame.

According to one embodiment, during the R-TWT schedule setup process, if an R-TWT scheduled STA indicates a TID in the R-TWT Traffic Info field of the R-TWT Parameter Set field in the TWT element, but the R-TWT scheduled STA does not send the QoS Characteristics element corresponding to that TID to its associated R-TWT scheduling AP, the R-TWT scheduling AP requests for the QoS Characteristics element corresponding to that TID from that R-TWT scheduled STA.

According to one embodiment, the QoS Characteristics element is added into the TWT Setup frame. The format of the proposed TWT Setup frame is shown in Table I.

TABLE I
TWT Setup frame with QoS Characteristic
element

| Order | Information |
|---|---|
| 1 | Category |
| 2 | Unprotected SIG Action |
| 3 | Dialog Token |
| 4 | One or more TWT |
| 5 | QoS Characteristics |

According to one embodiment, a TWT Setup process can occur per stream classification service (SCS) instead of the TID. According to one embodiment, a R-TWT Traffic Info field can list the SCS identifier (SCSID) instead of the TID for which the R-TWT setup is being carried on. According to another embodiment, for finer resolution differentiation of the traffic stream, for each TID indicated in the R-TWT Traffic Info field, more than one SCSID can also be indicated in the corresponding TWT element.

According to one embodiment, if the SCSID is used for the R-TWT setup process, the R-TWT scheduled STA and the R-TWT scheduling AP also perform the corresponding SCS negotiation for the SCSID by exchanging the SCS Request frame and the SCS Response frame.

According to one embodiment, the SCS Descriptor element is added into the TWT Setup frame. The format of the proposed TWT Setup frame is shown in Table II.

TABLE II
TWT Setup frame with SCS Descriptor
element

| Order | Information |
|---|---|
| 1 | Category |
| 2 | Unprotected SIG Action |
| 3 | Dialog Token |
| 4 | One or more TWT |
| 5 | QoS Characteristics |
| 6 | SCS Descriptor |

According to one embodiment, in order for faster TWT negotiation, if an R-TWT scheduling AP does not accept the requested TIDs/SCSIDs requested by the R-TWT scheduled STA but agrees with the other TWT parameters, the R-TWT scheduling AP can indicate, separately from the indication of other TWT parameters, the TIDs/SCSIDs that the R-TWT scheduling AP recommends for that R-TWT scheduled STA.

According to one embodiment, in order for faster TWT negotiation, if an R-TWT scheduled STA includes the TIDs/SCSIDs for which the R-TWT schedule is being setup, it indicates Demand TWT in the TWT Setup Command field.

According to embodiments of the present disclosure, the entire QoS Characteristics element is proposed to be sent before R-TWT negotiation happens. Information needed by the AP for understanding the non-AP STA's traffic pattern and traffic requirements is contained within the QoS Characteristics element. How the AP uses different information to identify a latency-sensitive stream and allocate R-TWT membership to different STAs depends on the AP's implementation. Based on different scenarios, the AP's decision can change based on the information available from the QoS Characteristics element. The following two examples illustrate how the same information from the QoS Characteristics elements from the STA may change the AP's decision at different times.
a. In one example: consider the case where two STAs, STA1 and STA2, request membership of an R-TWT schedule and send their respective QoS Characteristics. Both STAs request TID 3 for the R-TWT stream. STA1 indicates the Delay Bound subfield in its QoS Characteristics element as 100 us, whereas STA2 indicates the Delay Bound subfield in its QoS Characteristics element as 50 us. However, assume that the AP can allow one STA in the R-TWT schedule. Although both STAs indicate TID 3 as a low-latency stream, the AP can grant STA2 the R-TWT membership based on its lower delay bound.
b. In one example: Same scenario as above. However, this time assume that the AP can allow two STAs in the R-TWT schedule. The AP may decide to grant R-TWT membership to both STA1 and STA2.
   i. In the above example 2, the AP uses Delay Bound information in the QoS Characteristics element to justify R-TWT membership. Another AP may use other information along with Delay Bound information. Hence, how the AP uses different information within the QoS Characteristics element for granting R-TWT membership depends on the AP's implementation.

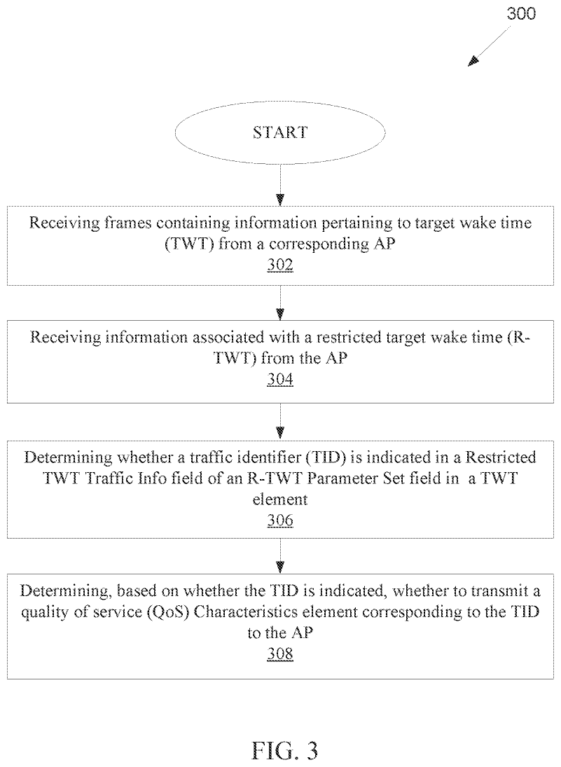

FIG. 3 illustrates a flow chart of a method 300 for wireless communication as may be performed by a non-AP station, such as STA 114 illustrated in FIG. 1, according to embodiments of the present disclosure. The embodiment of the method 300 illustrated in FIG. 3 is for illustration only. FIG. 3 does not limit the scope of this disclosure to any particular implementation.

As illustrated in FIG. 3, the method 300 begins at step 302. In step 302, the STA receives frames containing information pertaining to target wake time (TWT) from a corresponding AP.

In step 304, the STA receives information associated with a restricted target wake time (R-TWT) from the AP.

In step 306, the STA determines whether a traffic identifier (TID) is indicated in a R-TWT Traffic Info field of an R-TWT Parameter Set field in a TWT element.

In step 308, the STA determines, based on whether the TID is indicated, whether to transmit a quality of service (QoS) Characteristics element corresponding to the TID to the AP.

In one embodiment, based on the TID is being indicated, the STA transmits the QoS Characteristic elements corresponding to the TID to the AP; based on the TID is not being indicated, the STA does not transmit the QoS Characteristics element corresponding to the TID to the AP; and the STA receives another TWT element with a TWT Setup Command field set to Reject TWT from the AP.

In one embodiment, based on the TID is not being indicated, the STA does not transmit the QoS Characteristics element corresponding to the TID to the AP; the STA receives an Alternate TWT or a Dictate TWT in a TWT Setup Command field; and the STA receives a response frame that excludes a corresponding TID from the R-TWT Traffic Info field of the R-TWT Parameter Set field.

In one embodiment, based on the TID is not being indicated, the STA does not transmit the QoS Characteristics element corresponding to the TID to the AP; and the STA receives a request for the QoS Characteristics element corresponding to the TID from the AP.

In one embodiment, a TWT Setup frame includes the QoS characteristics element.

In one embodiment, the STA determines whether a Stream Classification Service Identifier (SCS ID) is indicated in the R-TWT Traffic Info field of the R-TWT Parameter Set field in a TWT element; and for each TID indicated in the R-TWT Traffic Info field, indicates a plurality of SCS IDs in a TWT Setup frame.

In one embodiment, a TWT frame includes a stream classification service (SCS) Descriptor element or a QoS Characteristics element in an SCS Request frame.

The above flowcharts illustrate example methods that can be implemented in accordance with the principles of the present disclosure and various changes could be made to the methods illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A non-access point (AP) station comprising:
a transceiver configured to:
receive frames containing information pertaining to target wake time (TWT) from a corresponding AP; and
receive information associated with a restricted target wake time (R-TWT) from the AP; and
a processor coupled to the transceiver, the processor configured to:
determine whether a traffic identifier (TID) is indicated in a R-TWT Traffic Info field of an R-TWT Parameter Set field in a TWT element; and
determine, based on whether the TID is indicated, whether to instruct the transceiver to transmit a quality of service (QoS) Characteristics element corresponding to the TID to the AP.

2. The non-AP station of claim 1, wherein:
based on the TID is being indicated, the transceiver transmits the QoS Characteristics element corresponding to the TID to the AP,
based on the TID is not being indicated, the transceiver does not transmit the QoS Characteristics element corresponding to the TID to the AP, and
the transceiver is configured to receive another TWT element with a TWT Setup Command field set to Reject TWT from the AP.

3. The non-AP station of claim 1, wherein:
based on the TID is not being indicated, the transceiver does not transmit the QoS Characteristics element corresponding to the TID to the AP, and
the transceiver is configured to:
receive an Alternate TWT or a Dictate TWT in a TWT Setup Command field, and
receive a response frame that excludes a corresponding TID from the R-TWT Traffic Info field of the R-TWT Parameter Set field.

4. The non-AP station of claim 1, wherein:
based on the TID is not being indicated, the transceiver does not transmit the QoS Characteristics element corresponding to the TID to the AP, and
the transceiver is configured to receive a request for the QoS Characteristics element corresponding to the TID from the AP.

5. The non-AP station of claim 1, wherein a TWT Setup frame includes the QoS characteristics element.

6. The non-AP station of claim 1, wherein:
the processor is configured to determine whether a Stream Classification Service Identifier (SCS ID) is indicated in the R-TWT Traffic Info field of the R-TWT Parameter Set field in a TWT element, and
for each TID indicated in the R-TWT Traffic Info field, a plurality of SCS IDs are indicated in a TWT Setup frame.

7. The non-AP station of claim 1, wherein a TWT frame includes a stream classification service (SCS) Descriptor element or a QoS Characteristics element in an SCS Request frame.

8. A method for wireless communication performed by a non-access point (AP) station, the method comprising:
receiving frames containing information pertaining to target wake time (TWT) from a corresponding AP;
receiving information associated with a restricted target wake time (R-TWT) from the AP;
determining whether a traffic identifier (TID) is indicated in a R-TWT Traffic Info field of an R-TWT Parameter Set field in a TWT element; and
determining, based on whether the TID is indicated, whether to transmit a quality of service (QoS) Characteristics element corresponding to the TID to the AP.

9. The method of claim 8, further comprising:
based on the TID is being indicated, transmitting the QoS Characteristic elements corresponding to the TID to the AP;
based on the TID is not being indicated, not transmitting the QoS Characteristics element corresponding to the TID to the AP; and
receiving another TWT element with a TWT Setup Command field set to Reject TWT from the AP.

10. The method of claim 8, further comprising:
based on the TID is not being indicated, not transmitting the QoS Characteristics element corresponding to the TID to the AP;
receiving an Alternate TWT or a Dictate TWT in a TWT Setup Command field; and
receiving a response frame that excludes a corresponding TID from the R-TWT Traffic Info field of the R-TWT Parameter Set field.

11. The method of claim 8, further comprising:
based on the TID is not being indicated, not transmitting the QoS Characteristics element corresponding to the TID to the AP; and
receiving a request for the QoS Characteristics element corresponding to the TID from the AP.

12. The method of claim 8, wherein a TWT Setup frame includes the QoS characteristics element.

13. The method of claim 8, further comprising:
determining whether a Stream Classification Service Identifier (SCS ID) is indicated in the R-TWT Traffic Info field of the R-TWT Parameter Set field in a TWT element; and
for each TID indicated in the R-TWT Traffic Info field, indicating a plurality of SCS IDs in a TWT Setup frame.

14. The method of claim 8, wherein a TWT frame includes a stream classification service (SCS) Descriptor element or a QoS Characteristics element in an SCS Request frame.

15. A non-transitory, computer readable medium comprising instructions that, when executed by a processor of a non-access point (AP) station, cause the non-AP station to:
receive frames containing information pertaining to target wake time (TWT) from a corresponding AP;
receive information associated with a restricted target wake time (R-TWT) from the AP;
determine whether a traffic identifier (TID) is indicated in a R-TWT Traffic Info field of an R-TWT Parameter Set field in a TWT element; and
determine, based on whether the TID is indicated, whether to transmit a quality of service (QoS) Characteristics element corresponding to the TID to the AP.

16. The computer readable medium of claim 15, further comprising instructions that, when executed by the processor, cause the non-AP station to:
based on the TID is being indicated, transmit the QoS Characteristic elements corresponding to the TID to the AP;
based on the TID is not being indicated, not transmit the QoS Characteristics element corresponding to the TID to the AP; and
receive another TWT element with a TWT Setup Command field set to Reject TWT from the AP.

17. The computer readable medium of claim 15, further comprising instructions that, when executed by the processor, cause the non-AP station to:
based on the TID is not being indicated, not transmit the QoS Characteristics element corresponding to the TID to the AP;
receive an Alternate TWT or a Dictate TWT in a TWT Setup Command field; and
receive a response frame that excludes a corresponding TID from the R-TWT Traffic Info field of the R-TWT Parameter Set field.

18. The computer readable medium of claim 15, further comprising instructions that, when executed by the processor, cause the non-AP station to:
based on the TID is not being indicated, not transmit the QoS Characteristics element corresponding to the TID to the AP; and
receive a request for the QoS Characteristics element corresponding to the TID from the AP.

19. The computer readable medium of claim 15, further comprising instructions that, when executed by the processor, cause the non-AP station to:
determine whether a Stream Classification Service Identifier (SCS ID) is indicated in the R-TWT Traffic Info field of the R-TWT Parameter Set field in a TWT element; and
for each TID indicated in the R-TWT Traffic Info field, indicate a plurality of SCS IDs in a TWT Setup frame.

20. The computer readable medium of claim 15, further comprising instructions that, when executed by the processor, cause the non-AP station to include a stream classification service (SCS) Descriptor element or a QoS Characteristics element in an SCS Request frame in a TWT frame.
